(19) United States
(12) Patent Application Publication
(10) Pub. No.: US 2023/0072645 A1
(43) Pub. Date: Mar. 9, 2023

(54) POLYMER SOLID WOOD COMPOSITE FLOORING AND PREPARATION METHOD THEREOF

(71) Applicant: ZHEJIANG YUFENG INTELLIGENT HOME CO., LTD., HUZHOU (CN)

(72) Inventors: LIUSHUN NI, HUZHOU (CN); RONG DU, HUZHOU (CN); CHUNLI FANG, HUZHOU (CN); XIANXU ZHAN, HUZHOU (CN); YINYOU LIN, HUZHOU (CN); LIPING ZHANG, HUZHOU (CN); RONGJIA CHENFANG, HUZHOU (CN); YANFENG LU, HUZHOU (CN)

(21) Appl. No.: 17/527,079

(22) Filed: Nov. 15, 2021

(30) Foreign Application Priority Data
Aug. 18, 2021 (CN) 202110946190.6

(51) Int. Cl. B32B 21/08; B32B 21/14; B32B 27/20; B32B 27/08; B32B 37/10; B32B 3/06; E04F 15/02; E04F 15/10

(52) U.S. Cl. CPC B32B 21/08; B32B 21/14; B32B 27/20; B32B 27/08; B32B 37/10; B32B 3/06; E04F 15/02038; E04F 15/107; B32B 2255/26; B32B 2419/04; B32B 2307/554; B32B 2307/54; B32B 2307/536; B32B 2307/7145; B29C 48/022

(57) ABSTRACT

The invention relates to a floor. The polymer solid wood composite flooring includes a SPC stone plastic layer, and a solid wood veneer layer or plywood layer forming the main body of the floor is arranged under the SPC stone plastic layer; the physical and chemical performance index of the polymer solid wood composite flooring is: color fastness≥Grade 6; average peel strength≥75 (N/50 mm), pollution resistance≥grade 5, heating dimensional change rate≤0.25%, heating warpage≤2.0 mm, moisture content 6-10%. The preparation process of polymer solid wood composite flooring includes: preparation of SPC stone plastic layer; preparation of solid wood veneer layer or plywood layer; composite pressing; first balance treatment; Slitting; second balance treatment; slotting; UV layer preparation. Thereby, the polymer solid wood composite flooring with good foot feeling, not easy to deform and crack, and small dimensional change rate is produced.

### TECHNICAL FIELD

The invention relates to a floor, in particular to a polymer solid wood composite flooring.

### BACKGROUND TECHNIQUE

Traditional ceramic floors, solid wood floors, and composite flooring have ice-hard feet, easy deformation, and excessive formaldehyde, which can no longer meet people's requirements. There is an urgent need for a soft, non-deformable and environmentally friendly indoor floor. The main component of PVC flooring is polyvinyl chloride material, which is widely used in all aspects of home and business because of its rich patterns and diversified colors.

SPC floor is a new type of floor, also known as stone-plastic floor. Its base material is a composite board made of stone powder and thermoplastic polymer material after being evenly mixed and then extruded at high temperature. At the same time, it has the properties and characteristics of wood and plastic. To ensure the strength and toughness of the floor. The density of traditional SPC stone plastic floor is 1900-2000 kg/m³. Since the thickness of the SPC floor is 2-3 mm, it has extremely high requirements for leveling during decoration, and there are problems such as poor foot feel and difficult installation.

### SUMMARY OF THE INVENTION

The first objective of the present invention is to overcome the above-mentioned difficulties and provide a polymer solid wood composite flooring with good foot feel and easy installation.

The second object of the present invention is to overcome the above-mentioned difficulties and provide a method for preparing a polymer solid wood composite flooring with good foot feel and easy installation.

The above-mentioned first technical objective of the present invention is achieved through the following technical solutions:

A polymer solid wood composite flooring, comprising a SPC stone plastic layer, a solid wood veneer layer or a plywood layer forming the main body of the floor is arranged under the SPC stone plastic layer; the physical and chemical performance indexes of the polymer solid wood composite flooring are: color fastness≥Degree 6; average peel strength≥75 (N/50 mm), pollution resistance≥5, heating dimensional change rate≤0.25%, heating warpage≤2.0 mm, moisture content 6-10%.

After many experiments conducted by the inventor, the polymer solid wood composite flooring of the present invention is provided with a solid wood veneer layer or a plywood layer forming the main body of the floor under the SPC stone plastic layer, which has a good foot feeling and is convenient to install. The invention utilizes the fireproof performance, antibacterial and waterproof performance of the SPC floor, the stability of solid wood/plywood, and the good performance of wood foot feel, and through material composite, solves the shortcomings of poor foot feel, high installation requirements and difficult installation of the stone-plastic floor.

Preferably, the plywood layer has a two-layer structure, a five-layer structure, a seven-layer structure and a nine-layer structure.

Preferably, an UV paint layer, a wear-resistant sheet layer and a resin film layer are sequentially arranged above the SPC layer from top to bottom.

Preferably, the physical and chemical performance indicators of the polymer solid wood composite flooring are: elastic modulus≥4000 MPa, static bending strength≥30 MPa, surface wear resistance≤0.08 g/100r, paint film hardness≥2H, total volatile matter limit≤40 g/m³, soluble cadmium (Cd)≤20 mg/m², soluble lead (Pb)≤20 mg/m², formaldehyde emission≤0.050 mg/m³, warpage of hot and cold 2.0 mm, mildew resistances 1.

Preferably, the slot size indexes of the polymer solid wood composite flooring are:

Straight angle qmax≤0.1 mm; edge irregularity smax≤0.15 mm;

Warpage: Convex warpage in the width direction fw≤0.20%; Concave warpage in the width direction fw≤0.15%; Convex warpage in the length direction fl≤0.5%, Concave warpage in the length direction fl≤0.25%.

Preferably, when the main body of the floor under the SPC layer is a plywood layer, the performance indicators of the plywood are: moisture content 10-12%, elastic modulus≥4000 MPa, static bending strength≥40 MPa, formaldehyde emission≤0.025 mg/m³.

Preferably, the physical and chemical performance indexes requirements of the SPC layer are: color fastness≥grade 6; average peel strength≥75 (N/50 mm), pollution resistance≥grade 5, mildew resistance≤grade 1, and heating dimensional change rate≤0.25%, heating warpage≤2.0 mm, warpage of cold and hot≤2.0 mm, soluble cadmium (Cd)≤20 mg/m², soluble lead (Pb)≤20 mg/m², formaldehyde emission≤0.025 mg/m³.

As a preferred technical solution of the present invention, the composite board includes a bottom plate layer, a stone plastic PVC layer, a wear-resistant sheet layer, a resin film layer, and a UV wear-resistant paint film layer. The stone plastic PVC layer is bonded to the bottom plate layer, and the wear-resistant sheet layer is bonded to the stone plastic PVC layer, the resin film layer is bonded to the wear-resistant sheet layer, and the UV wear-resistant paint film layer is bonded to the resin film layer.

Preferably, a solid wood composite flooring includes a composite board, a clamping block and a clamping groove, one side of the composite board is integrally formed with the clamping block, and the clamping groove is opened on the side of the composite board opposite to the clamping block, and the clamping block matches the clamping groove;

Wherein, the clamping block is provided with a right-angle clamping groove, a position of the clamping block close to the right-angle clamping groove is integrally formed with a trapezoidal convex block, and a strip groove is formed at the bottom joint of the clamping block and the composite board, the right-angled clamping groove and the strip-shaped groove are both through-type;

Wherein, a right-angle bump is fixedly connected to the side of the composite board near the clamping groove, the side of the composite board near the clamping groove is provided with a trapezoidal groove, and the side of the composite board near the clamping groove are integrally formed with strip bumps.

Multiple solid wood composite flooring can be nested and fixed to each other. By inserting the clamping block on one solid wood composite flooring into the clamping groove on the other solid wood composite flooring, the connection and fixation between the multiple solid wood composite flooring of the present invention can be realized. After the two solid wood composite flooring of the present invention are connected, the right-angle bump will be inserted into the right-angle clamping groove, the trapezoidal bump will be inserted into the trapezoidal groove, the strip bump will be inserted into the strip groove, and the three sets of pin slots will match and interact with each other. Improve the stability of the solid wood composite flooring connection. Among them, the trapezoidal bumps interact with the trapezoidal grooves to effectively prevent the longitudinal staggered displacement between the solid wood composite flooring. The right-angle bumps are matched with the right-angled grooves, and the strip bumps are matched with the strip grooves. It can effectively prevent the lateral displacement between the solid wood composite flooring; at the same time, when connecting, the clamping block can be inserted into the clamping groove obliquely, and the clamping block can be easily and completely matched and inserted into the clamping groove by lightly shaking the clamping block. The connection is convenient and fast.

As a preferred technical solution of the present invention, the bottom plate is provided with an inner groove, two symmetrically arranged storage grooves are opened in the inner groove, and the bottom plate is provided with side grooves.

As a preferred technical solution of the present invention, the stone plastic PVC layer is integrally formed with two symmetrically arranged connecting plates, the bottom of the stone plastic PVC layer is provided with a cross groove, and the connecting plate is bonded in the side groove.

As a preferred technical solution of the present invention, the right-angled protrusion is matched with the right-angled clamping groove, the trapezoidal protrusion is matched with the trapezoidal groove, and the strip-shaped groove is matched with the strip-shaped protrusion.

As a preferred technical solution of the present invention, the corner angle of the lower left corner of the trapezoidal convex block is greater than 90° and less than 150°.

As a preferred technical solution of the present invention, the bottom plate is solid wood veneer or multi-layer plywood.

The above-mentioned second technical objective of the present invention is achieved through the following technical solutions:

Preparation process of polymer solid wood composite flooring, including:

(1) Preparation of SPC layer;

(2) Preparation of solid wood veneer layer or plywood layer;

(3) Composite pressing: laminate the SPC layer and solid wood veneer layer or plywood layer;

(4) First balance treatment;

(5) Slitting;

(6) Second balance treatment;

(7) Slotting;

(8) Preparation of UV layer.

In the present invention, the solid wood veneer layer or plywood layer forming the main body of the floor is compositely pressed under the SPC layer, and then the balance treatment is performed before and after the slitting, so as to obtain a good foot feeling, not easy to deform and crack, and a size change rate of less than 0.25% Polymer solid wood composite flooring.

Preferably, the preparation of the SPC layer includes the following steps:

S1, raw material ratio:including polyvinyl chloride resin powder 80-90 parts by weight, calcium carbonate 160-180 parts by weight, calcium titanate 10-30 parts by weight, internal lubricant 0.6-0.8 parts by weight, polyethylene wax 1.0-1.2 parts by weight, chlorinated polyethylene 2-4 parts by weight, acrylate 0.8-1.5 parts by weight, compound lubricant 0.6-0.9 parts by weight, liquid barium zinc stabilizer 2-3 parts by weight;

S2, put the above-mentioned raw materials into a high-speed mixer for mixing and heating, then low-speed stirring to cool down, and then extrude through an extruder.

Lubricants can be divided into internal lubrication and external lubrication. The main function of the external lubricant is to improve the friction between the polymer melt and the hot metal surface of the processing equipment. It has poor compatibility with polymers and is easy to migrate from the melt, so it can form a lubricating thin layer at the interface between the plastic melt and the metal. The internal lubricant has good compatibility with the polymer. It plays a role in reducing the intermolecular cohesion of the polymer inside the polymer, thereby improving the internal friction and heat generation of the plastic melt and the fluidity of the melt. Because the external lubricant is easy to migrate from the melt to the outside, the plastic melt is easy to separate from the mold after molding, so the external lubricant is often called a release agent. However, the internal lubricant and the external lubricant are not absolute, and will change according to the properties of the melt. Such as the common lubricants polyethylene wax and stearic acid; when used in polyethylene resin, polyethylene wax has better compatibility and stays in the resin as an internal lubricant; when used in polyvinyl chloride resin, stearic acid The acid compatibility is better, and it stays inside the resin as an internal lubricant, while the polyethylene wax has poor compatibility and migrates out of the resin as an external lubricant.

Compound lubricants usually refer to polyol lipids. Such as caprylic acid, capric acid, lauric acid, palmitic acid, oleic acid, stearic acid, arachidic acid, sidic acid, sebacic acid, etc., which are composed of polyhydric alcohol lipids through esterification, alcoholysis, and transesterification. Lubricant for polymer compound alcohol ester products composed of multiple esterification and compound composition. In this type of lubricants, polyol ester products are part of the esterification of polyols, and there are still unreacted hydroxyl groups in the esters. Polar hydroxyl groups often endow products with good antistatic effects. Therefore, these lubricants are also antistatic agents in PVC processing. The pentaerythritol fatty acid ester is a mixture containing mono-, di-, tri-, and 4-esters. It has a good internal lubrication effect in PVC processing.

Preferably, the step (3) composite pressing process parameters include: cold pressing temperature 10-45° C., pressure: 15±0.5 MPa, time: 40-45 minutes, wherein the pressure-free parking time is controlled within 20 minutes, the pressed products must be stored for more than 72 hours for post-curing treatment.

The composite pressing process of the present invention must strictly control the temperature, pressure and time; if the cold pressing temperature and pressure are too low, the glue used in the composite pressing is likely to form a film layer between the SPC layer and the plywood layer, and it is difficult to penetrate the upper and lower layers. The SPC layer and the plywood layer have poor pressing effect, significantly reduce the bonding strength, and the composite board is easy to loosen; if the cold pressing temperature and pressure are too high, the moisture content of the composite board will be too low, which will affect the foot feel of the polymer solid wood composite flooring. Decrease stability; and it will affect the bonding performance of the glue, causing the floor to deform, crack and warp.

More preferably, the glue used in the composite pressing is required to be formaldehyde-free glue or water-free glue.

More preferably, the glue used in the composite pressing is isocyanate or other cold pressing glue.

Preferably, the step (6) the second balance treatment includes stacking the cut panels according to “#”, and it must be protected from moisture, wrapped around with stretch film, and must be balanced for more than 72 hours before entering into the slotting process.

Preferably, the plywood layer is a two-layer or multi-layer veneer material with more than two layers formed by peeling wood sections into veneers or cutting wood squares into veneers, and then gluing them with an adhesive, and the fiber directions of the adjacent layers of veneers are glued together perpendicular to each other; the veneer material is a veneer after plasma modification of the surface of the wooden veneer.

More preferably, the adhesive is prepared by the blending technology of methylolated lignin and melamine-urea-formaldehyde resin, and the preparation method includes: using a ball milling method at an oscillation frequency of 10-50 Hz to process 40-80 min to obtain wood powder; then form hydroxymethylated lignin through addition reaction with formaldehyde solution and solid alkali; mix hydroxymethylated lignin at a ratio of 20-40 wt % with MUF resin to obtain low-formaldehyde wood vegetarian-melamine urea-formaldehyde resin adhesive.

Further preferably, the adhesive is prepared by the blending technology of methylolated lignin and melamine-urea-formaldehyde resin, specifically by using a ball milling method at an oscillation frequency of 20 Hz for 60 minutes to obtain lignin powder; and methylolated lignin if formed by formaldehyde solution and solid alkali substance undergo addition reaction; methylolated lignin at a ratio of 30 wt % of is uniformly mixed with MUF resin to prepare low-formaldehyde lignin-melamine urea-formaldehyde resin adhesive.

More preferably, the plasma modification process of the wood veneer surface specifically includes: using atmospheric pressure and low temperature dielectric barrier discharge plasma technology to modify the wood veneer, and using the etching effect of plasma to change the micro structure of the veneer surface.

The present invention reconstructs a highly active surface layer with nanostructures on the surface of the veneer through plasma modification, and uses the effects of plasma oxidation, decomposition and grafting to introduce specific polar functional groups on the surface of the veneer, thereby promoting the adhesion of the adhesive for the interfacial bonding between woods, the bonding strength of composite materials made by using low-temperature plasma to modify the wood veneer without changing the amount of adhesive is increased by 15-50%. Under the premise of ensuring that the product quality meets the requirements of the national standard, the adhesive dosage can be reduced by 10-25% compared with the conventional dosage, which significantly reduces the production cost and reduces the free formaldehyde release of the product.

Using atmospheric pressure low-temperature dielectric barrier discharge plasma (DBD) technology to modify the wood veneer, using the etching effect of plasma to change the microstructure of the veneer surface, and promote the adhesive to be more evenly distributed on the wood surface. The contact area is greatly increased. At the same time, specific polar functional groups are introduced on the surface of the veneer by the effects of plasma oxidation, decomposition and grafting, thereby promoting the interface between the adhesive and the wood, and greatly improving the quality of the wood composite material. For wood composite materials with different performance requirements, the atmospheric pressure and low temperature plasma treatment process (including discharge time, discharge power, number of electrodes, discharge distance, etc.) and the characteristics of the veneer (such as veneer moisture content, etc.) can be adjusted by adjusting the atmospheric pressure and low temperature plasma treatment process, and Environmentally friendly urea-formaldehyde resin adhesive sizing and gluing process (such as sizing amount, hot pressing temperature, hot pressing time, etc.), can make the product obtain different gluing properties, and form the industrialized production of wood composite materials at atmospheric pressure and low temperature plasma modification technology.

In summary, the present invention has the following beneficial effects:

1, After many experiments conducted by the inventor, the polymer solid wood composite flooring of the present invention is provided with a solid wood veneer layer or a plywood layer forming the main body of the floor under the SPC layer, which has a good foot feeling and is convenient to install. The invention utilizes the fireproof performance, antibacterial, waterproof performance of the SPC floor, the stability of solid wood/plywood, and the wood foot feel performance, and through material composite, solves the shortcomings of poor foot feel, high installation requirements and difficult installation of the stone-plastic floor;

2, In the present invention, the solid wood veneer layer or plywood layer forming the main body of the floor is compositely pressed under the SPC stone plastic layer, and then the balance treatment is performed before and after the slitting, so that the product has a good foot feel, is not easy to deform and crack, and has a dimensional change rate of 0.2%. The following polymer solid wood composite flooring

### DESCRIPTION OF THE DRAWINGS

FIG. 1 is a stereogram of the solid wood composite flooring of the present invention;

FIG. 2 is a schematic diagram of the explosive structure of the present invention;

FIG. 3 is a schematic diagram of the structure of the stone plastic PVC of the present invention;

FIG. 4 is a cross-sectional view of the composite board of the present invention;

FIG. 5 is an enlarged schematic diagram of the structure of area A in FIG. 1 of the present invention;

FIG. 6 is an enlarged schematic diagram of the structure of zone B in FIG. 1 of the present invention.

In the picture: 1. composite board; 2. clamping block; 3. clamping groove; 11. bottom plate; 12. stone plastic PVC; 13. wear-resistant sheet; 14. resin film; 15. UV wear-resistant paint film; 21. right angle clamping groove; 22. trapezoidal convex block; 23. strip groove; 31, right angle convex block; 32. trapezoidal groove; 33. strip convex block; 121. connecting plate; 111. side groove; 112. inner groove; 113. placement slot; 122. cross groove.

### DETAILED WAYS

### Example 1

The polymer solid wood composite flooring includes the SPC layer. The solid wood veneer layer or plywood layer forming the main body of the floor is arranged under the SPC layer; the physical and chemical performance indicators of the polymer solid wood composite flooring are: color fastness≥6; average peel strength≥75 (N/50 mm), pollution resistance≥5 grade, heating dimensional change rate≤0.25%, heating warpage≤2.0 mm, moisture content 6-10%.

In order to further improve the foot feel, abrasion resistance and reduce the rate of dimensional change of the composite flooring, a UV paint layer, a wear-resistant sheet layer and a resin film layer are sequentially arranged above the SPC layer from top to bottom.

Preparation process of polymer solid wood composite flooring, include:

(1) Preparation of SPC layer;

(2) Preparation of solid wood veneer layer or plywood layer;

(3) Composite pressing: cold pressing the SPC layer and solid wood veneer layer or plywood layer;

(4) First balance treatment;

(5) Slitting;

(6) Second balance treatment;

(7) Slotting;

(8) Preparation of UV layer.

The preparation of the SPC layer includes the following steps:

S1, Raw material ratio: by weight, including 80 parts of polyvinyl chloride resin powder, 160 parts of calcium carbonate, 10 parts of calcium titanate, 0.6 parts of internal lubricant, 1.0 part of polyethylene wax, 2 parts of chlorinated polyethylene, 0.8 parts of acrylate, 0.6 parts of compound lubricant, 3 parts of liquid barium zinc stabilizer;

S2, The above-mentioned raw materials are put into a high-speed mixer for mixing and heating, then low-speed stirring is used to cool down, and then extruded through an extruder.

Step (3) The composite pressing process parameters include: cold pressing temperature 10° C., pressure: 15 MPa, time: 40 minutes, of which the no-pressure parking time is 15 minutes, and the pressing product is stored for 72 hours for post-curing treatment.

2, Plywood Control Standard

| Test items | Unit | Performance |
|---|---|---|
| Moisture content | % | 10-12 |
| Dip peeling | — | The cumulative peeling length of |
| | | each side of the same adhesive |
| | | layer of each test piece does not |
| | | exceed 25 mm (≥5 pieces) |
| Elastic Modulus | MPa | ≥4000 |
| Static bending strength | MPa | ≥40 |
| Formaldehyde emission | mg/m³ | ≤0.025 |

Remark: Elastic modulus and static bending strength, thickness≥6 mm requirements.

3, for Various Remarks Process Description:

3.1 Press Various Requirements:

3.1.1 Glue Requirements

Requirements for the glue used: formaldehyde-free glue and water-free glue (isocyanate or other cold-pressed glue)

3.1.2 Technical Requirements for Pressing Process:

After several pressing experiments and the performance test of the corresponding semi-finished products, it is considered the best under the following process conditions: cold pressing temperature (indoor): ≥30° C. and <30° C., the glue required formula is different, pay special attention to (It is strictly forbidden to press if the indoor temperature is lower than 10° C.). Pressure: 15±0.5 MPa, time: 40-45 minutes, the time of no-pressure parking is controlled within 20 minutes.

The pressed product must be stored for mote than 72 hours for post-curing before it can enter the slitting process.

3.2 Technical Requirements for Slitting

3.2.1 Standard Sizes:

The required size of the finished product is cut to leave enough allowance for the matching process

3.2.2 Appearance Quality Requirements:

| Defect name | Front | Back |
|---|---|---|
| Surface scratches | Not allowed | Not allowed |
| Surface indentation | Not allowed | |
| Burrs | The width does | Chipping with a |
| | not exceed 2 mm | width not exceed 2 mm |

3.3 For Balance Requirements:

After slitting, the small pieces are stacked according to “#”, they must be protected from moisture, wrapped around with stretch film, and 72 hours of balance treatment must be carried out before they can enter the slotting process;

3.4 Slotting Technical Requirements:

3.4.1 Quality requirements for the grooved appearance
of polymer solid wood composite flooring:

| Defect name | Front | Back |
|---|---|---|
| Surface scratches | Not allowed | According to the |
| Overprint deviation, pattern | Not obvious | requirements and |
| distortion | | standards on the |
| Wrinkles, bubbles | Not obvious | back of the solid |
| Color difference, impurities | Not obvious | wood composite |
| Black spots, pollution | Not obvious | flooring GB/T18103; |
| Missing print, missing film | Not allowed | |
| Delamination, holes | Not allowed | |
| Cracks, tears | Not allowed | |
| Defects, cracks | Not allowed | |
| Tongue and corner defects | Not allowed | |

3.4.2 Quality requirements for slotting size
of polymer solid wood composite flooring

| Project | Require |
|---|---|
| Net length deviation | The absolute value of the difference |
| of surface layer | between each measured value and the |
| | nominal length ≤ 1.0 mm |
| Surface layer net | The absolute value of the difference |
| width deviation | between each measured value and the |
| | nominal width ≤ 0.1 mm |
| Straight angle | qₘₐₓ ≤ 0.1 mm |
| Edge not straightness | sₘₐₓ ≤ 0.15 mm |
| Warpage | Convex warpage in the width direction |
| | f w ≤ 0.20%; Concave warpage [symbol] the |
| | width direction f w ≤ 0.15% |
| | Convex warpage in the length f l ≤ 0.5%; |
| | Concave warpage in the length f l ≤ 0.25% |
| Assembling heig [symbol] | Assembled height difference |
| difference | average: ≤0.1 mm; Max ≤ 0.15 mm |

[symbol]

indicates data missing or illegible when filed

3.5, Rolling Paint Production Technical Requirements

3.5.1 Appearance quality requirements of
polymer solid wood composite flooring:

| Defect name | Front | Back |
|---|---|---|
| Surface scratches | Not allowed | According to parquet |
| Surface indentation | Not allowed | GB/T18103 |
| Thoroughly | Not allowed | The regulations on the |
| Overprint deviation, pattern | Not obvious | back require standa [symbol] |
| distortion | | implementation; |
| Wrinkles, bubbles | Not obvious | |
| Color difference, impurities | Not obvious | |
| Black spots, pollution | Not obvious | |
| Missing print, missing film | Not allowed | |
| Delamination, holes | Not allowed | |
| Cracks, tears | Not allowed | |
| Defects, cracks | Not allowed | |
| Tongue and corner defects | Not allowed | |
| Paint film particles, pinhole [symbol] | Not allowed | |
| Paint film bubbling | Not allowed | |
| Paint film wrinkled skin | Not allowed | |
| Leak paint | Not allowed | |

[symbol]

indicates data missing or illegible when filed

3.5.2 The size and quality requirements
of polymer solid wood composite flooring:

| Project | Require |
|---|---|
| Net length deviation | The absolute value of the difference |
| [symbol] surface layer | between each measured value and the |
| | nominal length ≤ 1.0 mm |
| Surface layer net | The absolute value of the difference |
| wid [symbol] deviation | between each measured value and the |
| | nominal width ≤ 0.1 mm |
| Straight angle | qₘₐₓ ≤ 0.1 mm |
| Edge not straightness | sₘₐₓ ≤ 0.15 mm |
| Warpage | Convex warpage in the width direction |
| | f w ≤ 0.20%; Concave warpage [symbol] the width |
| | direction f w ≤ 0.15% |
| | Convex warpage in the length f l ≤ 0.5%; |
| | Concave warpage in the length f l ≤ 0.25% |
| Assembling height | Assembled height difference |
| difference | average: ≤0.1 mm; Max ≤ 0.15 mm |

[symbol]

indicates data missing or illegible when filed

3.5.3 Physical and chemical performance index
of polymer solid wood composite flooring:

| Test items | Unit | Index |
|---|---|---|
| Color fastness | grade | ≥6 grade |
| Average peel | (N/50 mm) | ≥75/≥70 |
| strength/Min | | |
| Resistant to | — | ≥5 grade |
| pollution/grade | | |
| Mildew | — | ≤1 grade |
| resistance/grade | | |
| Heating size | % | ≤0.025 |
| change rate | | |
| Heating | mm | ≤2.0 |
| warpage | | |
| Warpage of | mm | ≤2.0 |
| hot and cold | | |
| Formaldehyde | mg/m³ | ≤0.05 |
| emission | | |
| Soluble lead | mg/m² | ≤20 |
| (Pb) | | |
| Soluble | mg/m² | ≤20 |
| cadmium | | |
| (Cd) | | |
| Total volatile | g/m² | ≤40 |
| limit | | |
| Moisture | % | 6-10 |
| content | | |
| Surface | g/100 r | ≤0.08, And the paint |
| wear-resistant | | film is not worn through |
| Wear-resistant | — | ≥25000 |
| casters/r | | |
| Elastic | MPa | ≥4000 |
| Modulus | | |
| Static bending | MPa | ≥30 |
| strength | | |
| Dip peeling | — | The cumulative peeling |
| (6 slices) | | length of each side of |
| | | the same adhesive layer |
| | | of each test piece does |
| | | not exceed 25 mm |
| | | (≥5 slices) |
| Hardness of | — | ≥2H |
| paint film | | |
| Paint film | — | The paint film is allowed to |
| adhesion | | peel off at the intersection |
| | | of the cut marks, and a small |
| | | amount of intermittent peeling |
| | | of the paint film along the |
| | | cut marks is allowed |

3.6 Packaging Requirements

3.6.1 The product is processed and packaged separately according to product category and grade;

3.6.2 A copy of the installation and operation manual for consumers to read must be placed in the box;

3.6.3 Plastic packaging treatment prevents the product from being bumped, scratched and fouled, and prevents the product from drying out during transportation and storage, and the humidity change affects the quality of the board;

4, Characteristics of Polymer Solid Wood Composite Flooring

It not only has the characteristics of solid wood composite, good foot feel, simple installation, sound absorption and sound insulation, warmth, good heat preservation performance, but also has SPC floor wear resistance, environmental protection, non-toxic, harmless, antibacterial, flame retardant, waterproof and moisture-proof, and good insulation performance, Rich styles, anti-deformation, anti-pollution, non-fading and other characteristics. Polymer solid wood composite flooring improves the problem of poor foot feel of SPC flooring.

### Example 2

Same as Example 1, except that the preparation of the SPC layer includes the following steps:

S1, Raw material ratio: by weight, including 90 parts by weight of polyvinyl chloride resin powder, 180 parts of calcium carbonate, 30 parts of calcium titanate, 0.8 parts of internal lubricant, 1.2 parts of polyethylene wax, 4 parts of chlorinated polyethylene, 1.5 parts of acrylate, 0.9 parts of compound lubricant, 2 parts of liquid barium zinc stabilizer;

S2, The above-mentioned raw materials are put into a high-speed mixer for mixing and heating, then low-speed stirring is used to cool down, and then extruded through an extruder;

Step (3) The composite pressing process parameters include: cold pressing temperature 45° C., pressure: 14.5 MPa, time: 45 minutes, of which the no-pressure parking time is controlled within 20 minutes, and the pressing product is cured after 73 hours of storage deal with.

### Example 3

Same as Example 1, except that the preparation of the SPC layer includes the following steps:

S1, Raw material ratio: by weight, including 85 parts of polyvinyl chloride resin powder, 170 parts of calcium carbonate, 20 parts of calcium titanate, 0.7 parts of internal lubricant, 1.1 parts of polyethylene wax, 3 parts of chlorinated polyethylene, 1.2 parts of acrylate, 0.8 parts of compound lubricant, 2.3 parts of liquid barium zinc stabilizer;

S2, The above-mentioned raw materials are put into a high-speed mixer for mixing and heating, then low-speed stirring is used to cool down, and then extruded through an extruder;

Step (3) The composite pressing process parameters include: cold pressing temperature 25° C., pressure: 15.5 MPa, time: 42 minutes, of which the pressure-free parking time is controlled within 20 minutes, and the pressed product will be cured after 75 hours of storage deal with.

### Example 4

Same as Example 1, the difference is that the plywood layer is a two-layer or more multi-layered veneer formed by peeling wood pieces into veneer or sliced wood into veneer, and then glued together with an adhesive. The material is made by gluing the fiber directions of adjacent layers of veneers perpendicular to each other; the veneer material is a veneer modified by plasma on the surface of the wooden veneer.

Among them, the adhesive is prepared by the blending technology of methylolated lignin and melamine-urea-formaldehyde resin. The preparation method includes: using a ball milling method at an oscillation frequency of 10 Hz for 40 minutes to obtain lignin powder; and then mixing with formaldehyde solution Addition reaction with solid alkali substances to form hydroxymethylated lignin; the hydroxymethylated lignin is uniformly mixed with MUF resin at a ratio of 40 wt % to prepare a low-formaldehyde lignin-melamine urea-formaldehyde resin adhesive.

The plasma modification process of the wood veneer surface specifically includes: using atmospheric pressure and low temperature dielectric barrier discharge plasma technology to modify the wood veneer, and using the etching effect of plasma to change the surface microstructure of the veneer.

### Example 5

Same as Example 2, the difference is that the plywood layer is a two-layer or more multi-layered veneer formed by peeling a wooden section into a veneer or a wooden square sliced into a veneer, and then glued together with an adhesive. The material is made by gluing the fiber directions of adjacent layers of veneers perpendicular to each other; the veneer material is a veneer modified by plasma on the surface of the wooden veneer.

Among them, the adhesive is prepared by the blending technology of methylolated lignin and melamine-urea-formaldehyde resin. The preparation method includes: using a ball milling method to process 80 minutes at an oscillation frequency of 50 Hz to obtain lignin powder; Addition reaction with solid alkali substances to form hydroxymethylated lignin; the hydroxymethylated lignin is uniformly mixed with MUF resin at a ratio of 20 wt % to prepare a low-formaldehyde lignin-melamine urea-formaldehyde resin adhesive.

The plasma modification process of the wood veneer surface specifically includes: using atmospheric pressure and low temperature dielectric barrier discharge plasma technology to modify the wood veneer, and using the etching effect of plasma to change the surface microstructure of the veneer.

### Example 6

Same as Example 3, the difference is that the plywood layer is a two-layer or more multi-layered veneer formed by peeling wood pieces into veneer or sliced wood into veneer, and then glued together with an adhesive. The material is made by gluing the fiber directions of adjacent layers of veneers perpendicular to each other; the veneer material is a veneer modified by plasma on the surface of the wooden veneer.

The adhesive is prepared by the blending technology of methylolated lignin and melamine-urea-formaldehyde resin. Specifically, the lignin powder is obtained by treating it with a ball milling method at an oscillation frequency of 20 Hz for 60 minutes; and then through mixing with formaldehyde solution and solid alkali material Carry out addition reaction to form methylolated lignin; mix methylolated lignin with MUF resin at a ratio of 30% to obtain low-formaldehyde lignin-melamine urea-formaldehyde resin adhesive.

The plasma modification process of the wood veneer surface specifically includes: using atmospheric pressure and low temperature dielectric barrier discharge plasma technology to modify the wood veneer, and using the etching effect of plasma to change the microstructure of the veneer surface.

Please refer to FIG. 1-6. A solid wood composite flooring includes a composite board 1, a clamping block 2 and a clamping groove 3. It is characterized in that: one side of the composite board 1 is integrally formed with the clamping block 2, and the clamping groove 3 is opened in the composite board on the side opposite to the clamping block 2, the clamping block 2 matches the clamping groove 3. A plurality of solid wood composite flooring of the present invention can be nested and fixed to each other, by inserting the clamping block 2 on one solid wood composite flooring into the other a clamping groove 3 on a solid wood composite flooring realizes the connection and fixation between a plurality of solid wood composite flooring of the present invention;

Wherein, the clamping block 2 is provided with a right-angle clamping groove 21, the clamping block 2 is integrated with a trapezoidal protrusion 22 at a position close to the right-angle clamping groove 21, and the bottom connection of the clamping block 2 and the composite sheet 1 is provided with a strip groove 23, right-angled the clamping groove 21 and the strip groove 23 are both through-type. When the two parquets of the present invention are connected, the right-angled bump 31 will be inserted into the right-angled groove 21, and the trapezoidal bump 22 will be inserted into the trapezoidal groove 32. The bump 33 will be inserted into the strip groove 23. The three sets of pin grooves match and interact with each other to improve the stability of the solid wood composite flooring connection. Among them, the trapezoid bump 22 interacts with the trapezoidal groove 32 to effectively prevent the solid wood composite flooring from interacting with each other. Longitudinal staggered displacement, the right-angle protrusion 31 cooperates with the right-angle clamping groove 21, and the strip protrusion 33 cooperates with the strip groove 23, which can effectively prevent the lateral displacement between the solid wood composite flooring.

Among them, the side of the composite sheet 1 close to the clamping groove 3 is fixedly connected with a right-angle bump 31, the side of the composite sheet 1 close to the clamping groove 3 is provided with a trapezoidal groove 32, and the side of the composite sheet 1 close to the clamping groove 3 is integrally formed with a strip.

### Shaped Bump 33

Specifically, please refer to FIG. 4. The composite board 1 includes a bottom plate 11, a stone plastic PVC12, a wear-resistant sheet 13, a resin film 14 and a UV wear-resistant paint film 15. The stone plastic PVC12 is bonded to the bottom plate 11, and the wear-resistant sheet 13 is bonded connected to the stone plastic PVC12, the resin film 14 is bonded to the wear-resistant sheet 13, the UV wear-resistant paint film 15 is bonded to the resin film 14, the bottom plate 11 is solid wood veneer or multi-layer plywood, and the stone plastic PVC12 is used for to improve the strength of the solid wood composite flooring, the wear-resistant sheet 13 and the UV wear-resistant paint film 15 can improve the abrasion resistance of the solid wood composite flooring of the present invention.

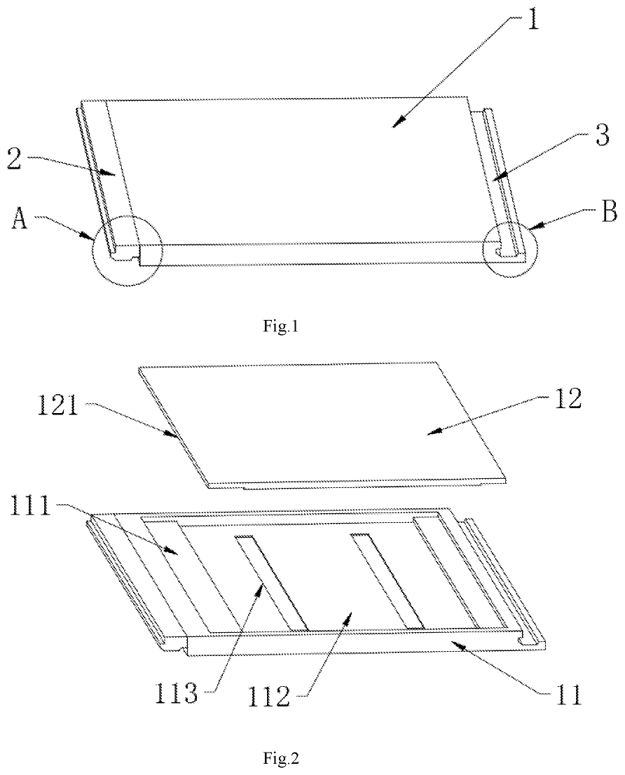

Specifically, please refer to FIG. 2. The bottom plate 11 is provided with an inner groove 112, and two symmetrical placement slot 113 are opened in the inner groove 112. The bottom plate 11 is provided with side grooves 111. The inner tank 112 can be filled with dry powder fire extinguishing agent, and a mixture of nitroglycerin, sulfur and charcoal wrapped by fireproof tape is placed in the placement slot 113.

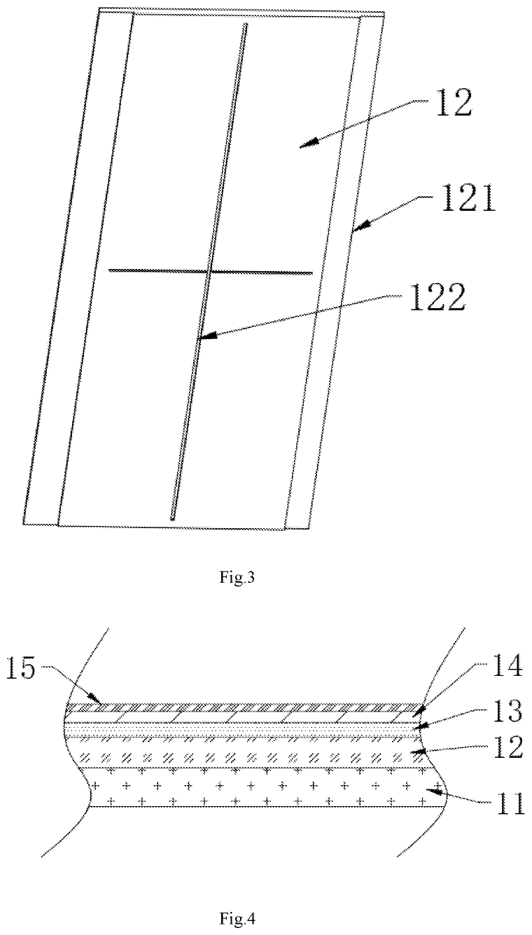

Specifically, please refer to FIG. 3. The stone plastic PVC12 is integrally formed with two symmetrically arranged connecting plates 121. The bottom of the stone plastic PVC12 is provided with a cross groove 122, and the connecting plate 121 is bonded in the side groove 111 and the cross groove 122 place the cross-shaped lead wire and insert the bottom end of the lead wire through the dry powder fire extinguishing agent and insert it into the fireproof tape. When the fire ignites the stone plastic PVC12, the lead wire is ignited to generate blasting force, and the dry powder fire extinguishing agent is sprayed around to achieve the effect of extinguishing fire.

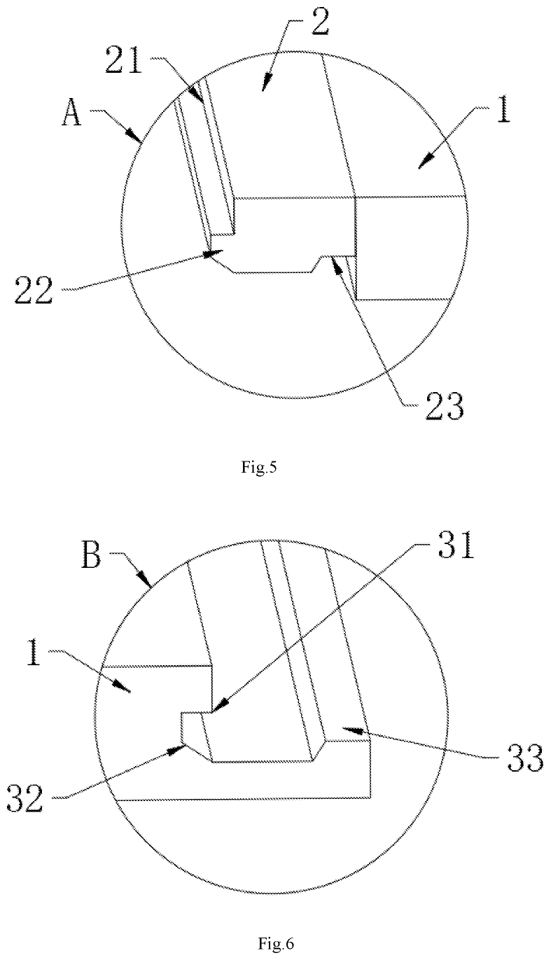

Specifically, please refer to FIG. 1, FIG. 5 and FIG. 6, the right-angle protrusion 31 is matched with the right-angle clamping groove 21, the trapezoidal protrusion 22 is matched with the trapezoidal groove 32, and the strip groove 23 is matched with the strip protrusion 33. The clamping block 2 can be tightly fitted after being inserted into the clamping groove 3 to improve the overall stability.

Specifically, please refer to FIG. 5, the angle of the lower left corner of the trapezoidal protrusion 22 is greater than ninety degrees and less than one hundred and fifty degrees, which facilitates the insertion of the parquets block 2 into the clamping groove 3.

Working principle: A plurality of solid wood composite flooring of the present invention can be nested and fixed to each other, and multiple solid wood composite flooring of the present invention can be realized by inserting the clamping block 2 on one solid wood composite flooring into the clamping groove 3 on the other solid wood composite flooring. When the two solid wood composite floorings of the present invention are connected, the right-angle protrusion 31 will be inserted into the right-angle groove 21, the trapezoidal protrusion 22 will be inserted into the trapezoidal groove 32, and the strip protrusion 33 will be inserted into the strip In the groove 23, the three sets of pin grooves are matched and interacted with each other to improve the stability of the solid wood composite flooring connection. Among them, the trapezoidal bump 22 interacts with the trapezoidal groove 32 to effectively prevent the longitudinal staggered displacement between the solid wood composite flooring. Right-angle bumps 31 is matched with the right-angle groove 21, and the strip protrusion 33 is matched with the strip groove 23, which can effectively prevent the lateral displacement between the solid wood composite floorings; at the same time, when connecting, the clamping block 2 can be inserted into the clamping groove 3 at an angle. Shake the clamping block 2 to insert the clamping block 2 into the clamping groove 3 in a convenient and fully matched fit, and the connection is convenient and fast.

### COMPARATIVE EXAMPLE 1

A polymer solid wood composite flooring, comprising a PVC board and a solid wood board. The PVC board and the solid wood board are glued and fixed as a whole; the PVC board is made of the following parts by weight of raw materials: 130 parts of PVC resin, calcium carbonate powder 320 parts, 1.5 parts of PE wax, 5.5 parts of calcium-zinc stabilizer, 12 parts of ACR-401, 4.5 parts of stearic acid. The thickness of the solid wood slab is 1 mm and the moisture content is 3%.

The preparation method of the above polymer solid wood composite flooring includes the following steps:

(1) Preparation of PVC Board:

Weigh out PVC resin, calcium carbonate powder, PE wax, calcium zinc stabilizer, ACR-401, stearic acid according to the formula ratio, add the above raw materials into the mixer and mix evenly to obtain a mixture; send the mixture into the double Extrude in the screw extruder to obtain PVC board;

(2) Preparation of polymer solid wood composite flooring: roll the end surface of the PVC board with environmentally friendly glue, and then paste the solid wood board skin, then place it in a cold press for 10 hours, then carry out UV roll coating treatment, and finally slit the groove, That is.

The dimensional change rate of the polymer solid wood composite flooring in Examples 1-6 and Comparative Example 1 of the present invention was tested, and the test conditions were: placed at 80° C. for 6 hours. The measured dimensional change rate is shown in Table 1:

TABLE 1
Dimensional change rate

| | Heating size | Heating | Average peel |
|---|---|---|---|
| | change rate % | warpage mm | strength N/50 mm |
| Example 1 | 0.25 | 1.5 | 76 |
| Example 2 | 0.23 | 1.43 | 77 |
| Example 3 | 0.21 | 1.41 | 78 |
| Example 4 | 0.19 | 1.39 | 79 |
| Example 5 | 0.20 | 1.37 | 80 |
| Example 6 | 0.18 | 1.35 | 82 |
| Comparative | 0.5 | 2.21 | 60 |
| Example 1 | | | |

The above data can be seen
1, The heating dimensional change rate of the polymer solid wood composite flooring prepared in Examples 1-6 is small, which is smaller than the dimensional change rate of Comparative Example 1 and the general solid wood composite flooring (the dimensional change rate of the general solid wood composite flooring is greater than 0.25%).
2, The heating warpage of the polymer solid wood composite flooring prepared in Examples 1-6 is small, which is smaller than the dimensional change rate of Comparative Example 1 and the general solid wood composite flooring;
3, The average peel strength of polymer solid wood composite flooring prepared in Examples 1-6 is relatively large, which is larger than the average value of peel strength of Comparative Example 1 and general solid wood composite flooring;
4, The polymer solid wood composite flooring of the present invention does not deform or crack during use, has stable performance and long service life.

This specific embodiment is only an explanation of the present invention, and it is not a limitation of the present invention. After reading this specification, those skilled in the art can make modifications to this embodiment without creative contribution as needed, but as long as the rights of the present invention The scope of the requirements is protected by the patent law.

1. A polymer solid wood composite flooring, characterized in that it comprises a SPC stone plastic layer, and a solid wood veneer layer or plywood layer forming the main body of the floor is arranged under the SPC stone plastic layer; physical and chemical performance indexes of the polymer solid wood composite flooring are: color fastness≥6; average peel strength≥75 (N/50 mm), pollution resistance≥5, heating size change rate≤0.025%, heating warpage≤2.0 mm, moisture content 6-10%.

2. The polymer solid wood composite flooring according to claim 1, characterized in that: an UV layer, a wear-resistant sheet layer and a resin film layer are sequentially arranged above the SPC stone plastic layer from top to bottom.

3. The polymer solid wood composite flooring according to claim 2, characterized in that the physical and chemical performance indexes of the polymer solid wood composite flooring are: elastic modulus≥4000 MPa, static bending strength≥30 MPa, surface wear resistance≤0.08 g/100r, paint film hardness≥2H, total volatile matter limit≤40 g/m³, soluble cadmium (Cd)≤20 mg/m², soluble lead (Pb)≤20 mg/m², formaldehyde emission≤0.050 mg/m³, warpage of hot and cold≤2.0 mm, mildew resistance≤1 level.

4. The polymer solid wood composite flooring according to claim 3, characterized in that the slot size indexes of the polymer solid wood composite flooring are:
Straight angle qmax≤0.1 mm; edge irregularity smax≤0.15 mm;
Warpage: widthwise convex warpage fw≤0.20%; widthwise concave warpage fw≤0.15%; lengthwise convex warpage fl≤0.5%, lengthwise concave warpage fl≤0.25%.

5. The polymer solid wood composite flooring according to claim 4, characterized in that: the physical and chemical performance index of the polymer solid wood composite flooring is: when the main body of the floor under the SPC stone plastic layer is a plywood layer, the performance indexes of plywood are: moisture content 10-12%, elastic modulus≥4000 MPa, static bending strength≥40 MPa, formaldehyde emission≤0.025 mg/m³.

6. The polymer solid wood composite flooring according to claim 5, characterized in that: the physical and chemical performance indexes requirement of the SPC stone plastic layer are: color fastness≥6 Grade; average peel strength≥75 (N/50 mm), pollution resistance≥grade 5, mildew resistance≤grade 1, heating size change rate≤0.025%, heating warpage≤2.0 mm, cold and hot warpage≤2.0 mm, soluble cadmium (Cd)≤20 mg/m², soluble lead (Pb)≤20 mg/m², formaldehyde emission≤0.025 mg/m³.

7. A preparation process of the polymer solid wood composite flooring according to claim 1, characterized in that it comprises:
(1) Preparation of SPC layer;
(2) Preparation of solid wood veneer layer or plywood layer;
(3) Composite pressing: cold pressing the SPC layer and solid wood veneer layer or plywood layer;
(4) First balance treatment;
(5) Slitting;
(6) Second balance treatment;
(7) Slotting;
(8) Preparation of UV layer.

8. A preparation process of polymer solid wood composite flooring according to claim 7, characterized in that the preparation of the SPC layer comprises the following steps:
S1, raw material preparation: prepared by weight, including polyvinyl chloride resin powder 80-90, calcium carbonate 160-180, calcium titanate 10-30, internal lubricant 0.6-0.8, polyethylene wax 1.0-1.2, chlorinated polyethylene 2-4, acrylate 0.8-1.5, compound lubricant 0.6-0.9, liquid barium zinc stabilizer 2-3;
S2, put the above-mentioned raw materials into a high-speed mixer for mixing and heating, then low-speed stirring to cool down, and then extrude through an extruder.

9. The preparation process of polymer solid wood composite flooring according to claim 8, characterized in that the step (3) composite pressing process parameters include: cold pressing temperature 10-45° C., pressure: 15±0.5 MPa, time: 40-45 minutes, of which the non-pressure parking time is controlled within 20 minutes, and the pressed product must be stored for 72 hours for post-curing treatment.

10. The preparation process of polymer solid wood composite flooring according to claim 9, characterized in that the step (6) the second balance treatment includes stacking the divided boards according to “#”, and moisture-proof protection is required, wrapped with stretch film, and it must be balanced for more than 72 hours before it can enter the slotting process.
